(19) United States
(12) Patent Application Publication
(10) Pub. No.: US 2018/0215199 A1
(43) Pub. Date: Aug. 2, 2018

(54) Self-Steering Wheels for Overhead Crane or Train Car

(71) Applicant: REX Enterprises, LLC, Norfolk, NE (US)

(72) Inventor: Franklin Leroy Stebbing, Norfolk, NE (US)

(21) Appl. No.: 15/884,759

(22) Filed: Jan. 31, 2018

Related U.S. Application Data
(60) Provisional application No. 62/452,658, filed on Jan. 31, 2017.

(51) Int. Cl. B60B 17/00; B66C 9/08

(52) U.S. Cl. CPC B60B 17/0006; B66C 9/08

(57) ABSTRACT

A self-steering wheel for use with an overhead crane or a train car includes a trapezoidal shaped tread formed as part of the wheel. The trapezoidal shaped wheel tread, when riding on a steel track, will cause the wheel to self-steer and therefore cause self-steering of the overhead crane or train.

### CROSS-REFERENCE TO RELATED APPLICATION

This application claims priority to U.S. Provisional patent application Ser. No. 62/452,658, filed Jan. 31, 2017, the disclosure of which is incorporated herein in its entirety.

### FIELD OF INVENTION

The disclosure relates to wheels for overhead crane wheels and wheels for train cars, and more specifically to self-steering wheels for overhead cranes and train cars.

### BACKGROUND

Crane wheels, in particular, overhead traveling crane wheels, have been in use for more than one hundred years. They are a vital part of the crane and essential to safety. Many of these cranes are used in steel mills where they can be used to transport ladles with molten metal. Safety is paramount.

A typical crane wheel uses flanges on either side of the wheel to keep it on the track and to provide rudimentary steering. It is makeshift at best and the flanges and track are subjected to wear and friction. Lubricants are often used on the flanges but they often migrate to the tread area causing the wheels to slip and reducing braking. The lubricants can cause one end of the crane to slide out of alignment with the opposite end, resulting in skewing and structural stress.

Some crane wheels have flat treads 10 and some crane wheels included tapered treads 12 in an attempt to help the wheels steer the crane, as shown in FIG. 1. Tapered crane wheels have been used for over 100 years but their use is based on the premise that they will keep the crane traveling straight on the tracks. In fact, they will only steer in one direction and they will cause the crane to skew while traveling in the opposite direction, which is undesirable.

Train wheels have been in use for more than two hundred years. Nearly all of them use pairs of tapered tread wheels mounted on a common axle, as known in the art. The wheel assembly causes it to self-steer around curves or when there are variations in track straightness.

A problem exists because the conical-shaped, tapered treads result in the wheel load being applied to a point on the track and the wheel, instead of across the width of the track-tread interface. This results in very high unit loads, sometimes exceeding the elastic limit of the steel rails or wheels. When this happens the railhead or wheel tread can undergo permanent plastic deformation. The railhead becomes mushroom-shaped with the result that the wheel surface is no longer traveling at a uniform speed. Parts of the wheel are slipping and other areas are sliding along because of the different wheel diameters simultaneously in contact with the rail. The train wheel assemblies use flanges on the inside of the wheels to keep it on the track and to provide some back-up steering. The flanges and track are subjected to wear and friction.

Referring again to crane wheels, when the driven wheels are tapered, they will help to steer the crane when it is traveling in the direction that has the driven wheels in the lead. With the drivers “pulling” the crane and with the idlers trailing behind. When the bridge skews, or if the wheels are shifted too far to one side, then the larger end of the taper is in contact with the rail, as depicted by the right side wheel 14 shown in FIG. 2. The larger taper makes that wheel act just like it is a wheel but with a larger diameter, as depicted in FIG. 2.

On the opposite end of the bridge, that is, the wheel 16 on the left side shown in FIG. 2, that wheel is riding on its smaller taper, as depicted by FIG. 2. It acts like a smaller diameter wheel, so it travels less distance with each revolution; therefore it lags the faster, opposite end of the bridge. This is while it travels in the “good” direction with the drivers 14, 16 in the lead, as shown in FIGS. 3 and 4. If it moves toward either side, after a few revolutions, the active diameters equalize and the crane is traveling straight. The crane will hunt for a centered position on the rails.

Referring to FIG. 3, the crane is shown traveling in the “good” direction with the drivers 18 in the lead. If the crane skews towards either side, the active diameters equalize after a few revolutions and the crane travels straight.

Referring to FIG. 4, with the wheels traveling out of the page, the left wheel travels farther with each revolution; therefore, the wheels steer to the right and the idlers will follow. The crane will center on the rails as the active diameters equalize.

However, when the tapered wheels 14, 16 are “pushing” the crane, the exact opposite happens. As depicted in FIGS. 5 and 6, when the crane starts to skew, the larger taper will cause that end of the bridge to push even harder when it is the dominant, faster traveling wheel. So that the farther the crane skews out of alignment the more the “larger” wheel pushes in the wrong direction. The skewing problem is compounded and not relieved and the flanges will grind on the rail. Unless the flanges are much harder than the rail, the flanges will erode since there is more rail than there is flange.

Referring to FIG. 5, the crane is traveling in the bad direction with the drivers 14, 16 pushing. When the crane starts to skew, the larger taper will cause the end of the bridge to push harder since it is the dominant, faster traveling wheel.

Referring to FIG. 6, with the driver wheels 14, 16 traveling into the page, the left wheel travels farther with each revolution than the right wheel. The idler wheels (not shown) will be forced to the right. The drivers continue to push forward and to the left, compounding the skewing problem.

If the tapered treads have: (1) adequately robust, lubricated flanges, (2) if the tread width is not much greater than the width of the rail, (3) and if the rail is straight and parallel with the opposite rail, then the tapered treads may work acceptably. But, there can often be large differences in the rail environment from one side of the building to the other. Even variations while traveling the length of the building can be large. Additionally, local processing temperatures can vary greatly, with undesirable thermal rail expansion distortions, creating further problems.

Referring to FIG. 7, which shows a schematic view of an overhead crane 22 in a skewed position, the crane itself can possibly undergo some hefty stresses where the bridge girders connect to the end trucks if the crane is continuously subjected to skewing.

Referring to FIGS. 8A-C, with a tapered tread 24 on a flat rail 26, the entire load is concentrated on a single point 28 on the wheel tread, as shown more clearly in FIG. 8A. It also bears on a single point on the edge of the rail.

Referring to FIGS. 9A-C, with a straight tread 30 on a flat rail 26, the load is distributed, in a line 32, across the width of the rail, as shown more clearly in FIG. 8A.

In both a tapered and flat tread, the unit forces are high. With tapers, the unit forces are much higher. More specifically, with tapered treads, the stress in pounds per square inch is extremely high. In that instance, the area of a point is theoretically zero. So the stress in psi is: Stress=weight/area. Since the area is essentially zero the weight divided by zero results in a force that approaches infinity, S=weight/zero=infinity. Neither the hard rails nor alloy steel wheels can handle these stresses. They must undergo deformation. When the yield point is exceeded the deformation is permanent. There is a dished-shaped depression at the point where the force is applied, with the greatest stress in the center of the dimple. The rail surface is gradually reshaped as the moving wheel plows it down in parallel rows. The top of the rail is gradually cold-rolled into the sloped, angular shape of the tapered tread. However, now the tapered tread has different diameters in simultaneous contact with the rail, so part of the tread is now traveling faster and other parts are slower, an undesirable effect. Most of the wheel surface is skidding down the track as the crane travels along. Depending on the coefficient of friction, different areas of the wheel are sliding while other areas are gaining traction. Wheel and rail wear are the result, and so is skewing.

Based on the foregoing known problems with crane and train wheels, there remains a need for improvements in such crane and train wheels. The present invention provides such improvements.

### BRIEF SUMMARY

This summary is provided to introduce a selection of concepts in a simplified form that are further described below in the detailed description. The summary is not intended to identify key features or essential features of the claimed subject matter, nor is it intended to be used to limit the scope of the claimed subject matter.

According to an exemplary aspect, a wheel for an overhead crane or train comprises a circular wheel body defining at least one flange extending circumferentially outwardly from an outer edge of the circular wheel body. The wheel body also defines a tread configured to contact a rail on which the wheel will ride. The tread of the invention defines a trapezoidal shape that based on its shape and configuration will accomplish self-steering of the overhead crane or train. Additionally, the need for wheel flanges is reduced except as a backup in case of a mishap.

### BRIEF DESCRIPTION OF THE DRAWINGS

The present invention is illustrated by way of example and not limited in the accompanying figures in which like reference numerals indicate similar elements and in which:

FIG. 1 is an elevation view of a known tapered tread bridge wheel (left image) and a known flat tread idler wheel (right image).

FIG. 2 is a top view of a wheel assembly used on an overhead crane.

FIG. 3 is another view of the assembly of FIG. 2 with the crane traveling in the direction indicated by the direction arrow.

FIG. 4 is an elevation end view of known tapered tread wheels riding on a rail.

FIG. 5 is another view of the assembly of FIG. 2 with the crane traveling in the direction indicated by the direction arrow.

FIG. 6 is an elevation end view of known tapered tread wheels riding on a rail.

FIG. 7 is a top schematic view of a wheel assembly used on an overhead crane in a skewed position.

FIG. 8A is an end elevation view of a tapered tread wheel on a rail.

FIG. 8B is top view of a tapered tread wheel on a rail.

FIG. 8C is a side elevation view of a tapered tread wheel on a rail.

FIG. 9A is an end elevation view of a flat tread wheel on a rail.

FIG. 9B is top view of a flat tread wheel on a rail.

FIG. 9C is a side elevation view of a flat tread wheel on a rail.

FIG. 10 is an end elevation view of an exemplary trapezoidal wheel of the invention for use with an overhead crane.

FIG. 11 is a top view of the exemplary trapezoidal wheel of FIG. 10.

FIG. 12 is a top view of the exemplary trapezoidal wheel of FIG. 10 off-set on the rail.

FIG. 13A is an end elevation view of the exemplary trapezoidal wheel of the invention and off-set on the rail.

FIG. 13B is top view of the exemplary trapezoidal wheel of the invention and off-set on the rail.

FIG. 13C is a side elevation view of the exemplary trapezoidal wheel of the invention and off-set on the rail.

FIG. 14 is an end elevation view of an exemplary trapezoidal wheel of the invention for use with a train.

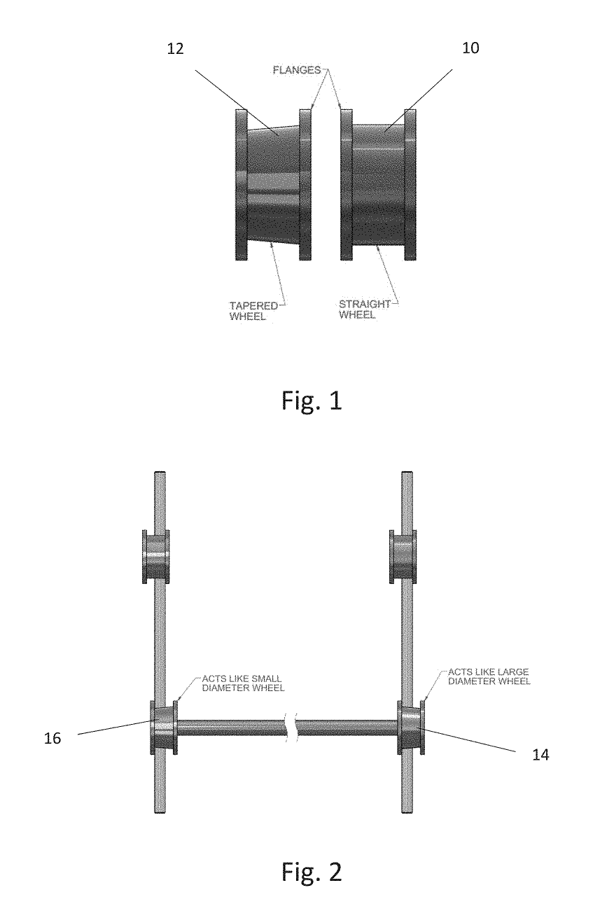

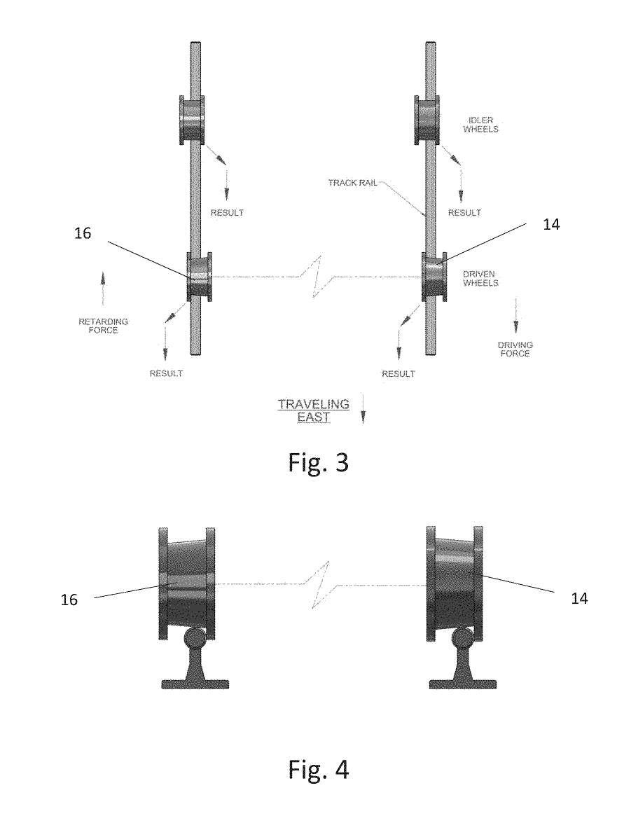

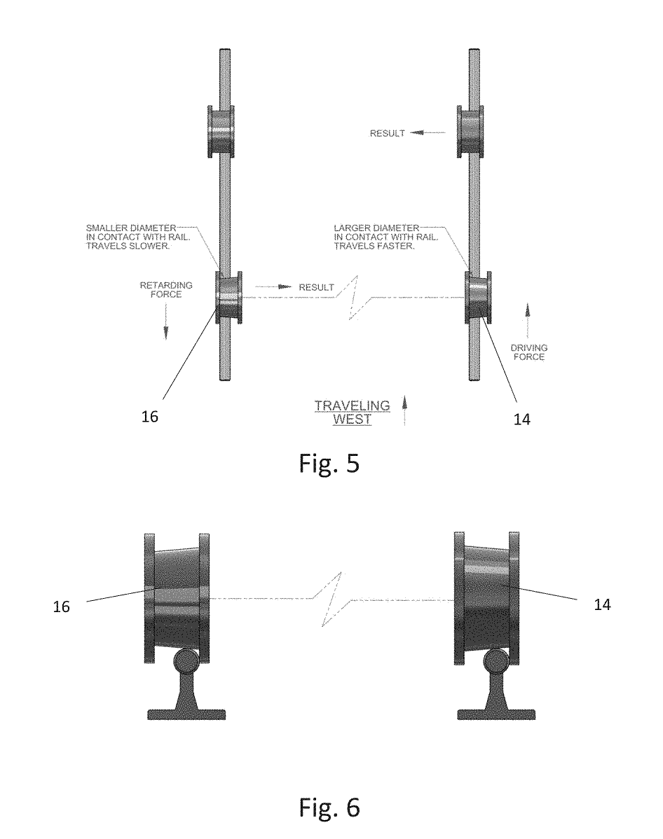

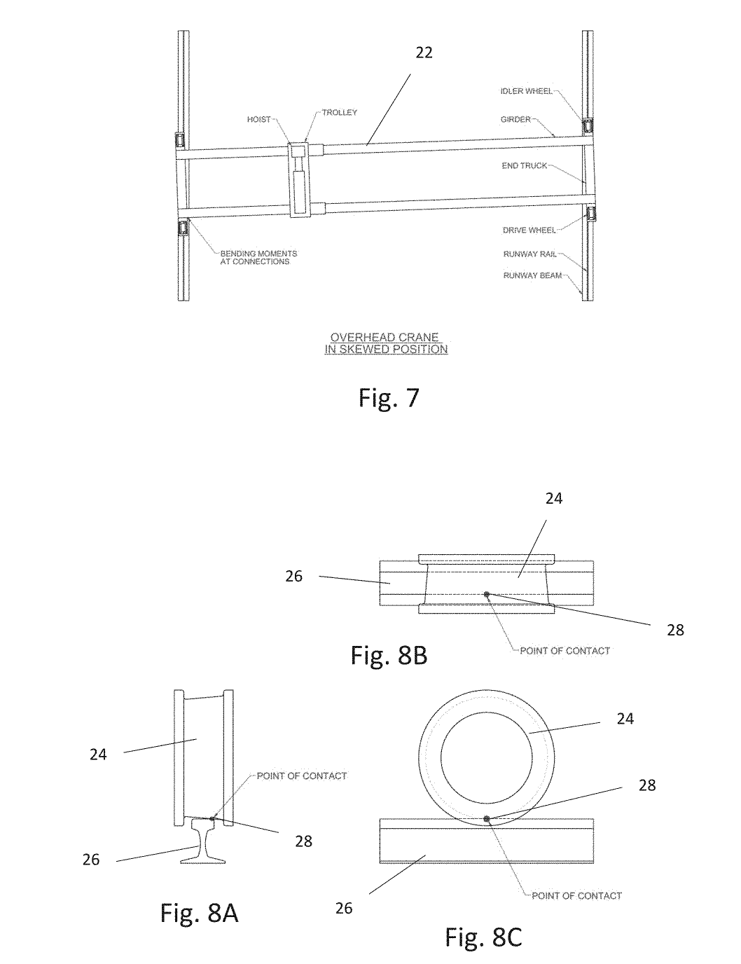

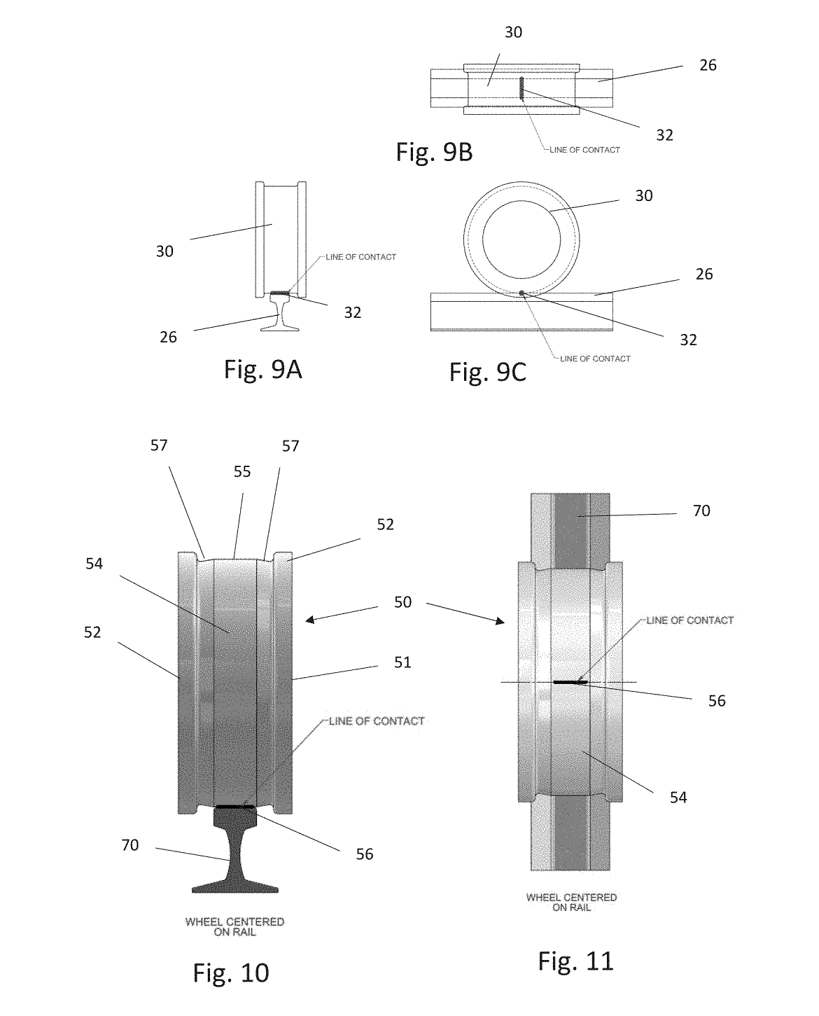

Further, it is to be understood that the drawings may represent the scale of different components of one single embodiment; however, the disclosed embodiments are not limited to that particular scale.

### DETAILED DESCRIPTION

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of this invention. Also, the reader is advised that the attached drawings are not necessarily drawn to scale.

The various figures in this application illustrate examples of self-steering wheels for overhead cranes and self-steering wheels according to this invention. When the same reference number appears in more than one drawing, that reference number is used consistently in this specification and the drawings refer to the same or similar parts throughout.

In one embodiment, and referring to FIG. 10, the invention comprises a wheel 50 that may be used with an overhead crane. The wheel 50 defines a circular wheel body 51 and a pair of opposing wheel flanges 52 extending circumferentially outwardly from opposing outer edges of the wheel body. The wheel also defines a thread 54 that has a trapezoidal shape. The trapezoidal shaped tread 54 accomplishes self-steering when the wheel is mounted to an overhead crane. In one embodiment, the trapezoidal shaped tread 54 is centrally located between the outer edges of the wheel body, as shown in FIG. 10.

In one embodiment, as shown in FIG. 10, the trapezoidal shaped tread 54 consists of a flat, central portion 55 along with two sloped surfaces 57 on either side of the flat surface 55. The flat surface is generally in contact with the rail when the wheel is centered on the rail, as shown in FIG. 10. Either of the two sloped portions 57 may be in contact with the rail when the wheel body is off center on the rail.

In one embodiment, for an exemplary 20-inch diameter crane wheel, the flat surface may have a width of approximately two inches, and the sloped surfaces may each have a width of approximately one inch. The sloped surfaces may slope at an angle of approximately 6.22 degrees from the flat surface. The sloped surfaces may slope at other angles greater or less than 6.22 degrees. In another alternative embodiment, the width of the flat surface may be greater or less than two inches. Similarly, the sloped surfaces may each have a width of greater than or less than one inch. Other dimensions of the flat surface and sloped surfaces are possible, depending on the size and type of crane or train wheel.

In an alternative embodiment, the trapezoidal shaped tread 54 may define a two dimensional isosceles trapezoidal tread profile shape. In another alternative embodiment, the tread 54 may be in the form of a very short pyramid with a flattened or truncated top with the shape being congruent.

With the trapezoidal shape 54 defined on the wheel 50, when riding on a steel track or rail 70, the trapezoidal shape will cause the wheel to self-steer, as explained below. Further, the need for flanges 52 is reduced except as a backup in case of a mishap.

As shown in FIG. 11, when the wheel 50 is centered on the track 70, the flat portion of the trapezoidal shape will ride flat on the track creating a line of contact 56.

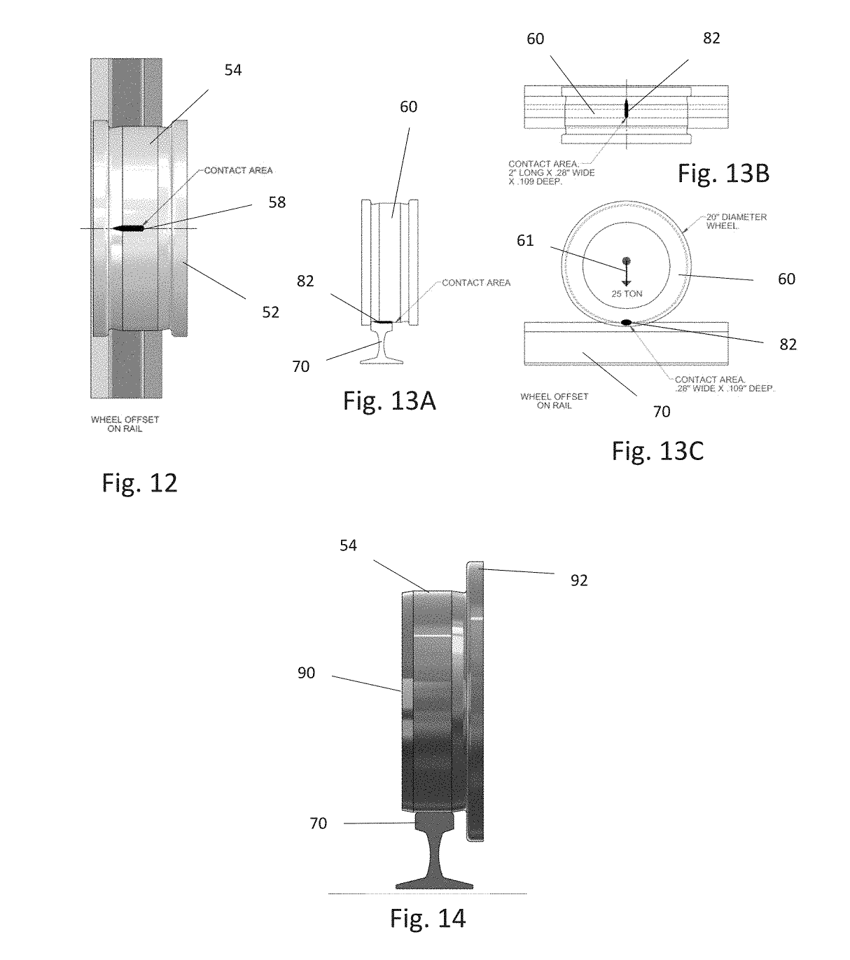

As shown in FIG. 12, when the wheel 50 is off-set on the track 70, the flat portion of the trapezoidal shape will ride flat on the track creating a line of contact 58 but the line of contact 58 shifts toward one side of the wheel.

It is understood that a radial surface, such as a wheel, will deform a flat surface, such as a rail, so that it conforms to the shape of the wheel. The deformation will take the shape of a trough, longitudinally along the rail, where the wheel presses down on it. In essence, a moving wheel is constantly pushing along in a trough. Additionally, the wheel has a flat spot where it contacts the flat surface. It is analogous to a softly inflated pneumatic tire, producing drag and resistance as it rolls along.

Referring to FIGS. 13A-C, an exemplary wheel 60, such as a 20-inch diameter crane wheel, may ride on a rail 80 and create a contact area 82. The wheel 60 may carry a load of 25 tons, as indicated by direction arrow 61. With the wheel centered on the rail 70, it may cause a deformation at the contact area 82 that is 2 inches long by 0.28 inches wide by 0.109 inches deep. The wheel can be thought of as continuously trying to climb out of a trough that is 0.109 inches deep. With the wheel offset to one side of the rail 80, as shown in FIG. 13A, the trough will be proportionally deeper and produce more drag on one side.

If the wheel 60 is centered on the rail 80 the drag forces generated by the trough are equalized across the wheel and rail width. However, when the wheel begins to migrate to either side, forces generated by the trough move sideways on the wheel. The drag forces are no longer equal. One side of the wheel is now subjected to a greater retarding force, while the force on the opposite side equals zero, since it is no longer riding on the track there. This dragging force tends to pull the wheel until it equalizes again. Depending on the orientation of the crane on the rails, one or more wheels can be trying to steer the crane at the same time. The wheels do not necessarily pivot into the direction to be steered. A force is applied that causes the wheel to move sideways and back to the center of the track, but they do not caster.

It is an understood principle of mechanics that a torque applied to a body can be considered as being applied to any point on the body. With one or more wheels applying torques, some clockwise and others counter-clockwise, the crane will be pulled so that it will eventually be centered on the rails. When the crane tries to wander on the rails the wheels will continuously force it back into alignment. The flanges will no longer be the main steering mechanism and will seldom touch the rail, and when they do it will be only for a brief period. They will not be continuously riding the rail as they often do now.

In some rare cases, if one of the rails is straighter than the opposite rail, or one end of the crane typically carries more weight than the other, the crane may only require steering wheels on one end only.

Referring to FIG. 14, in another exemplary embodiment of the invention, a train wheel 90 may define a flange 92 and may define a trapezoidal shape 94 tread to accomplish self-steering of the train wheel. In this exemplary embodiment, trapezoidal shape wheels, when riding on a steel track, cause the wheel to self-steer. Thus, the need for steering flanges 92 or conical, tapered treads is greatly reduced.

The trapezoidal shape of the tread may be similar to that described above with respect to the crane wheel and it may have similar dimensions as it relates to the flat surface and sloped surfaces, including the angles of the sloped surfaces. As indicated, other shapes and dimensions of the tread are possible.

As indicated above, a radial surface, such as a wheel, will deform a flat surface, such as a rail, so that it conforms to the shape of the wheel. As mentioned, the deformation will take the shape of a trough, longitudinally along the rail, where the wheel presses down on it. In essence, a moving wheel is constantly pushing along in a trough. Also, the wheel has a flat spot where it contacts the flat surface.

If the trapezoidal shaped wheel is centered on the rail, the drag forces generated by the trough and flattened tread area are equalized across the wheel and rail width. However, when the wheel begins to migrate to either side, the drag force moves toward one side. The drag forces are no longer equal. One side of the wheel is now subjected to a greater retarding force, while the other end sees none. This applies a dragging force to the wheel to try to steer it toward the center until it equalizes again. Depending on the orientation of the train on the rails, one or more wheels can be trying to steer the train at the same time. The wheels do not pivot into the direction to be steered. A force is applied that causes the wheel to move sideways and back to the center of the track, but they do not caster except as allowed by the bogie cars pivoting.

In some situations, if one of the rails is straighter than the opposite rail the train cars may only require steering wheels on one side, only. Or, alternate cars may have steering wheels on opposite sides of the cars since they must follow each other. This would help to equalize rail and wheel wear.

As indicated above, it is an understood principle of mechanics that a torque applied to a body can be considered as being applied to any point on the body. With one or more wheels applying torques, some clockwise and others counter-clockwise, the train will be steered so that it will eventually be centered on the rails. As the train tries to wander on the rails the wheels will continuously be steering it back into alignment. The flanges will no longer be the main steering mechanism and will seldom touch the rail, and when they do it will be only for a brief period, not riding against them continuously.

Conventional train wheels are mounted in sets, or pairs of wheels on a common axle. The ends of the axle contain bearings to allow the set to rotate. As previously mentioned, the common assembly causes the set to steer the crane around curves in the tracks. To do this, the pairs of wheels have to be of matched diameters, and rigidly mounted to the axle so they must rotate in unison and at the same rotational speed.

An advantage of the wheel 90 having a trapezoidal tread 90 is that the wheels no longer require a common axle connection between them. Nor do they require matched diameters. They can be independently mounted and have individual bearings in each wheel, with a stub axle. It is no longer necessary to lift the train car off of the bogie to change a set of wheels. The bogie is jacked up just enough to remove the wheel-bearing assembly and replaced with a new one.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

What is claimed is:

1. A wheel for an overhead crane comprising:
a circular wheel body defining at least one flange extending circumferentially outwardly from an outer edge of the circular wheel body,
the wheel body defining a tread configured to contact a rail,
wherein the tread defines a trapezoidal shape to accomplish self-steering of the overhead crane.

2. The wheel of claim 1, further comprising at least two opposing flanges extending circumferentially outwardly from the outer edge of the circular wheel body.

3. The wheel of claim 1, wherein the circular wheel body a pair of opposing outer edges, and wherein the trapezoidal shaped tread is centrally located between the outer edges of the wheel.

4. The wheel of claim 3, wherein the trapezoidal shaped tread defines a flat central portion and two sloped surfaces, one on each side of the flat surface.

5. The wheel of claim 4, wherein the flat surface may define a width of approximately two inches and the sloped surfaces may each have a width of approximately one inch.

6. The wheel of claim 5, wherein each of the sloped surfaces may slope at an angle of approximately 6.22 degrees from the flat surface.

7. A wheel for a train comprising:
a circular wheel body defining a flange extending circumferentially outwardly from an outer edge of the circular wheel body,
the wheel body defining a tread configured to contact a rail,
wherein the tread defines a trapezoidal shape to accomplish self-steering of the train.

8. The wheel of claim 7, wherein the circular wheel body defines a pair of opposing outer edges, and wherein the trapezoidal shaped tread is centrally located between the outer edges of the wheel.

9. The wheel of claim 8, wherein the trapezoidal shaped tread defines a flat central portion and two sloped surfaces, one on each side of the flat surface.

10. The wheel of claim 9, wherein the flat surface may define a width of approximately two inches and the sloped surfaces may each have a width of approximately one inch.

11. The wheel of claim 10, wherein each of the sloped surfaces may slope at an angle of approximately 6.22 degrees from the flat surface.
